(19) United States
(12) Patent Application Publication
(10) Pub. No.: US 2015/0368448 A1
(43) Pub. Date: Dec. 24, 2015

(54) RUBBER COMPOSITION FOR HOSES, AND HOSE

(71) Applicant: BRIDGESTONE CORPORATION, Chuo-ku, Tokyo (JP)

(72) Inventors: Atsushi KAWAI, Yokohama-shi (JP); Yohei TSUNENISHI, Yokohama-shi (JP); Takahiko SUZUKI, Yokohama-shi (JP)

(73) Assignee: BRIDGESTONE CORPORATION, Tokyo (JP)

(21) Appl. No.: 14/766,897

(22) PCT Filed: Feb. 7, 2014
(86) PCT No.: PCT/JP2014/052890

§ 371 Date: Aug. 10, 2015

(30) Foreign Application Priority Data
Feb. 13, 2013 (JP) 2013-025663

(51) Int. Cl. C08L 9/02; F16L 11/08

(52) U.S. Cl. CPC C08L 9/02; F16L 11/08; C08L 2207/04

(57) ABSTRACT

Rubber composition for hoses, containing 80 parts by mass or more of an acrylonitrile butadiene rubber (NBR) in 100 parts by mass of the rubber component, while containing 1-4 parts by mass of a phenolic resin and 1-5 parts by mass of a thiuram compound represented by general formula (1) and serving as a vulcanization accelerator, respectively per 100 parts by mass of the rubber component. This rubber composition is capable of achieving good adhesion to a brass-plated wire and is capable of solving the problems of environmental loads; and this rubber composition is particularly suitable for use as an inner tube rubber for hydraulic pressure hoses.

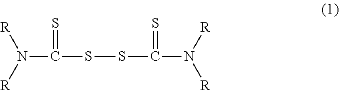

(In the formula, each R moiety represents an alkyl group having 6 or more carbons or an aryl group; and the R moieties may be different from each other, or two or more R moieties may be the same as each other.)

### TECHNICAL FIELD

The present invention relates to a rubber composition which has excellent adhesion to brass-plated wire and is particularly suitable for use as an inner tube rubber in hydraulic hose. The invention relates also to a hose produced using such a rubber composition.

### BACKGROUND ART

Acrylonitrile-butadiene rubber (NBR), which has an excellent oil resistance and heat resistance, is generally used as the inner tube rubber in hydraulic hose, and brass-plated wire is generally used as the reinforcing layer formed over the inner tube rubber. However, adhesion between the NBR and the brass-plated wire is not always sufficient, and separation at the interface sometimes arises due to bending, vibrations and the like during service, which may cause early product failure.

In such cases, increasing the sulfur content is effective for improving adhesion. Yet, at a high sulfur content, numerous crosslinkages form in the rubber, which lowers the heat resistance, making this approach impractical. In order to obtain a good adhesion at a sulfur content that allows the heat resistance to be maintained, methods have been described in which, for example, a phenolic resin or a maleic anhydride-modified polymer is included and made to form hydrogen bonds with functional groups on the brass plating (Patent Document 1: JP-A 58-72436; Patent Document 2: JP-A 59-162648).

However, methods that use these tackifiers invite problems such as increased cost and reduced workability. For example, in methods that use a phenolic resin, the rubber hardness rises, which may lead to a decline in fatigue resistance. In methods that use a modified polymer, due to functional groups on the modified polymer, the surface tackiness of the unvulcanized and vulcanized rubber may rise excessively, which can adversely affect workability, product appearance and the like.

One approach that has been proposed for resolving these problems and obtaining a good adhesion is a rubber composition which, by not including a tackifier and by using, as a vulcanization promoter, a thiuram compound such as tetramethylthiuram disulfide (TMTD), tetramethylthiuram monosulfide (TMTM), tetraethylthiuram disulfide (TETD) or tetrabutylthiuram disulfide (TBTD), adheres well to brass-plated wire without giving rise to the above problems (Patent Document 3: JP-A 2010-254876).

However, such thiuram compounds, owing to concerns over the generation of nitrosamines, which are harmful substances, and mutagenicity, are materials that pose high environmental risks. Moreover, it has also become apparent that bulging of the inner tube rubber (swelling of the rubber in places where a metal fitting has been crimped to the hose) tends to arise in hoses where the inner tube rubber is formed of a rubber composition in which the adhesion has been improved using a thiuram compound.

Various art has thus been proposed for improving the adhesion with brass-plated wire of rubber compositions for hoses, but the above problems remain unresolved and so there exists a desire for a solution.

### PRIOR ART DOCUMENTS

### Patent Documents

Patent Document 1: JP-A 58-72436

Patent Document 2: JP-A 59-162648

Patent Document 3: 2010-254876

### SUMMARY OF THE INVENTION

### Problems to be Solved by the Invention

It is therefore an object of the invention to provide a rubber composition which can achieve a good adhesion with brass-plated wire and is able to resolve the problems of environmental risk and bulging, particularly a rubber composition that can be suitably used as the inner tube rubber in hydraulic hose. A further object of the invention is to provide a hose in which such a rubber composition is used.

### Means for Solving the Problems

The inventors have conducted extensive investigations in order to achieve the above objects, discovering as a result that the generation of nitrosamines, which are harmful substances, can be minimized by using a thiuram compound of general formula (1) below

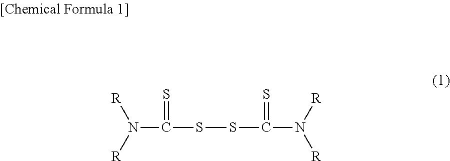

(wherein R is at each occurrence an alkyl group or aryl group of 6 or more carbons, each of which occurrences may be different or two or more of which may be the same) as a vulcanization accelerator, and moreover that sufficient adhesion to brass-plated wire can be achieved by optimizing the content of this thiuram compound and also concomitantly using a suitable amount of phenolic resin. Moreover, upon further investigation, the inventors have also found that the occurrence of bulging when the rubber composition is rendered into an inner tube rubber in hose can be minimized by adding a suitable amount of bismaleimide as a co-crosslinking agent. The inventors also investigated the optimal amounts of addition for other ingredients, such as sulfur and zinc white, ultimately arriving at the present invention.

Accordingly, this invention provides the following rubber composition for hoses and the following hose which uses such a rubber composition.

[Claim 1] A rubber composition for hoses, characterized by including 100 parts by mass of a rubber component, of which at least 80 parts by mass is an acrylonitrile-butadiene rubber (NBR); from 1 to 4 parts by mass of a phenolic resin; and, as a vulcanization accelerator, from 1 to 5 parts by mass of a thiuram compound of general formula (1) above.
[Claim 2] The rubber composition for hoses according to claim 1 which includes, as the thiuram compound of general formula (1), one or both of tetrabenzylthiuram disulfide and tetrakis(2-ethylhexyl)thiuram disulfide.
[Claim 3] The rubber composition for hoses according to claim 1 or 2 which includes from 1 to 5 parts by mass of bismaleimide.
[Claim 4] The rubber composition for hoses according to any one of claims 1 to 3 which includes from 1.5 to 3 parts by mass of sulfur.
[Claim 5] The rubber composition for hoses according to any one of claims 1 to 4 which includes from 0.5 to 10 parts by mass of zinc oxide (zinc white).
[Claim 6] The rubber composition for hoses according to any one of claims 1 to 5 which is a rubber composition that forms, in a rubber hose having a reinforcing layer made of brass-plated wire, a rubber layer which bonds directly with the brass-plated wire of the reinforcing layer.
[Claim 7] A hose comprising at least an inner tube rubber and a reinforcing layer made of brass-plated wire that is formed over the inner tube rubber, wherein the inner tube rubber is formed of the rubber composition according to any one of claims 1 to 6.
[Claim 8] The hose according to claim 7 which is a hydraulic hose that is filled with a hydraulic fluid for hydraulically powered equipment.

The rubber composition of the invention, owing to the use therein of a specific thiuram compound of formula (1) as a vulcanization accelerator, together with optimization of the amount of addition thereof, and also the addition of both this and a phenolic resin, can be advantageously used as a hydraulic hose inner tube rubber which is able to firmly bond to brass-plated wire used as a reinforcement in hydraulic hose without diminishing handleability and properties such as oil resistance, and moreover which can dispel to the extent possible the problem of environmental risk due to nitrosoamine generation.

Therefore, by forming the inner tube rubber of a hose from the rubber composition of the invention, this inner tube rubber and the brass-plated wire of the reinforcing layer firmly adhere to each other, making it possible to obtain a hose of excellent durability in which these two layers do not separate even during use under harsh conditions. Moreover, because the amount of tackifier addition, which increases the cost of the rubber, has been optimized, a rubber that is outstanding in terms of cost performance can be obtained. In addition, concerns over adverse effects on rubber properties other than adhesion, such as increased rubber hardness, decreased workability and retarding of the vulcanization rate that are associated with the addition of various tackifiers are absent. Also, unlike when conventional thiuram compounds are used, there is no environmental risk due to nitrosamine generation. Furthermore, in cases where a suitable amount of bismaleimide is added as a co-crosslinking agent, the occurrence of bulging can be more effectively suppressed, enabling a highly reliable hose to be obtained.

### Advantageous Effects of the Invention

The rubber composition of the invention, by using a thiuram compound as a vulcanization accelerator, enables excellent adhesion with the brass-plated wire used as a reinforcement in hydraulic hose to be obtained without giving rise to problems of cost and workability, and does not, as when conventional thiuram compounds are used, give rise to environmental risk due to nitrosamines. In addition, the occurrence of bulging that is seen in cases where conventional thiuram compounds are used can be minimized. Therefore, by using the rubber composition of the invention in the inner tube rubber of hydraulic hose, it is possible to provide hydraulic hoses that are endowed with excellent durability, reliability and cost performance, and that moreover present little environmental risk.

### BRIEF DESCRIPTION OF THE DIAGRAMS

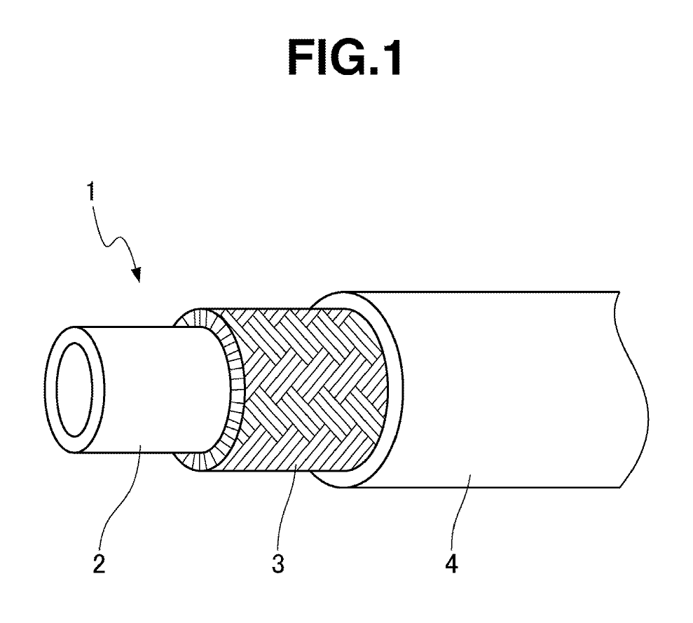

FIG. 1 is a schematic perspective view showing an embodiment of a hydraulic hose according to the invention.

### EMBODIMENT FOR CARRYING OUT THE INVENTION

The rubber composition for hoses of the invention is a composition which uses a rubber component that includes a given proportion of acrylonitrile-butadiene rubber (NBR), and which moreover includes, as a vulcanization accelerator, a given amount of a specific thiuram compound of above general formula (1) and includes also a given amount of a phenolic resin. In particular, this rubber composition can be preferably used as the rubber which forms an inner rubber layer 2 in the hydraulic hose 1 shown in FIG. 1.

The rubber component includes NBR. The amount of NBR in the rubber component is at least 80 parts by mass, preferably at least 90 parts by mass, and more preferably 100 parts by mass, per 100 parts by mass of the rubber component. In cases where the amount of NBR is lower than the above range, this may invite a decline in adhesion.

The NBR is not particularly limited; a known NBR may be suitably selected and used, although it is preferable for the amount of acrylonitrile (AN content) in the NBR to be in the range of 28 to 41 mass %, and especially 35 to 41 mass %. An acrylonitrile content greater than 41 mass % may invite declines in the low-temperature properties and fatigue resistance and a rise in hardness, whereas the desired oil resistance may not be achievable at an acrylonitrile content below 28 mass %.

A known natural or synthetic rubber, for example, may be included as the portion of the rubber component other than the above NBR. Illustrative examples include synthetic rubbers such as butadiene rubber, styrene-butadiene rubber, ethylene-propylene-diene rubber, isoprene rubber, butyl rubber, halogenated butyl rubber, chloroprene rubber, isobutylene-isoprene rubber, acrylonitrile-butadiene rubber, silicone rubber, acrylic rubber, epoxidized natural rubber, and acrylate-butadiene rubber, and such synthetic rubbers or natural rubbers that have been modified at the molecular chain ends. Any one, two or more of these may be suitably selected and used. In cases where such a rubber is included, the amount is preferably set to 20 parts by mass or less, and especially 10 parts by mass or less, of the 100 parts by mass of the rubber component.

In this invention, a thiuram compound of general formula (1) below

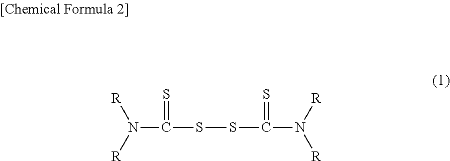

(wherein R is at each occurrence an alkyl group or aryl group of 6 or more carbons, each of which occurrences may be different or two or more of which may be the same) may be used as the vulcanization accelerator.

Here, as mentioned above, R in formula (1) is at each occurrence an alkyl group or aryl group of 6 or more carbons. Of these four occurrences of R, as noted above, each may be different, two or more may be the same, or all four occurrences of R may be the same.

Hence, the thiuram compound is not particularly limited, although the use of tetrabenzylthiuram disulfide (TBZTD) or tetrakis(2-ethylhexyl)thiuram disulfide is preferred. Commercial products may be used as these thiuram compounds. For example, Nocceler TBZTD (TBZTD) and Nocceler TOT-N (tetrakis(2-ethylhexyl)thiuram disulfide), both available from Ouchi Shinko Chemical Industry Co., Ltd., may be used.

The thiuram compound of general formula (1) is used as a vulcanization accelerator, and can effectively improve adhesion of the rubber composition to a reinforcement such as brass-plated wire. Moreover, because substantially no nitrosamine vaporizes from the vulcanizate obtained using this thiuram compound, a rubber vulcanizate that presents little environmental risk can be obtained. The content of this thiuram compound per 100 parts by mass of the rubber component is set to from 1 to 5 parts by mass, and preferably from 2 to 4 parts by mass. At a content below 1 part by mass, a good adhesion is not obtained; an adequate vulcanization rate also is not obtained, which may have a very adverse effect on the productivity. Moreover, due to a decrease in the high-temperature modulus of elasticity, it may not be possible to adequately suppress the occurrence of bulging. On the other hand, at more than 5 parts by mass, a large amount of bloom tends to arise on the rubber surface following vulcanization, in addition to which the use of so much thiuram compound is disadvantageous in terms of cost. Furthermore, the scorching time shortens, which may lead to a decline in the scorch stability.

Vulcanization accelerators other than thiuram compounds, such as thiazole-type (e.g., 2-mercaptobenzothiazole (MBT), dibenzothiazoyl disulfide (MBTS)), guanidine-type (e.g., di-o-tolylguanidine (DOTG), 1,3-diphenylguanidine (DPG)) and sulfonamide-type (N-cyclohexyl-2-benzothiazolyl sulfenamide (CBS), N-tert-butyl-2-benzothiazolyl sulfenamide (BBS)) compounds may also be included in the rubber composition of the invention within a range that does not depart from the objects of the invention. When these vulcanization accelerators other than thiuram compounds are included, the content thereof is preferably set in a range of not more than 2 parts by mass, and such that the combined amount of these together with the thiuram compound is not more than 5 parts by mass, per 100 parts by mass of the rubber component.

The thiuram compound of above general formula (1) has an adhesion enhancing effect which is somewhat inferior to that in cases where compounds such as the hitherto used tetramethylthiuram monosulfide (TMTM), tetraethylthiuram disulfide (TETD) or tetrabutylthiuram disulfide (TBTD) are included. Hence, in this invention, including also a phenolic resin compensates for the decrease in adhesion, resulting in an adhesion that is just as good as when a conventional thiuram compound is used.

The phenolic resin is not particularly limited, and may be a novolak-type or a resole-type phenolic resin, and moreover may be an unmodified or a modified phenolic resin such as a cashew nut oil-modified, oil-modified or rosin-modified phenolic resin. However, preferred use can be made of, for example, a cashew nut oil-modified phenolic resin. The phenolic resin content per 100 parts by mass of the rubber component is set to from 1 to 4 parts by mass, and preferably from 2 to 3 parts by mass. At a phenolic resin content below 1 part by mass, sufficient adhesion may not be obtainable. On the other hand, at more than 4 parts by mass, the high-temperature modulus of elasticity may decrease and it may not be possible to suppress the occurrence of bulging. Moreover, the scorching time shortens, lowering the scorch stability.

There is a possibility that adding a large amount of phenolic resin will invite a rise in the hardness at normal temperature and a decrease in fatigue resistance. Thus, in this invention, the amount of addition is held to a minimum, thereby making such effects as small as possible. Also, according to investigations by the inventors, it was found that when phenolic resin is added, the hardness at normal temperature rises and, at the same time, the modulus of elasticity at high temperatures decreases, which may exert an adverse influence on bulging. Hence, in this invention, although not particularly limited, to enhance the high-temperature modulus of elasticity and more effectively prevent the occurrence of bulging, it is desirable to add a suitable amount of bismaleimide. Here, “bulging” refers to the phenomenon of swelling by a rubber member close to where a metal fitting is crimped, due to use under high-temperature conditions (about 80° C. or above). When such swelling becomes large, breaks and cracks ultimately arise in the rubber, causing the contents to leak from the hose. If, in such cases, the degree of crimping is lowered to suppress such bulging, the secureness and fluid tightness of the hose end up being inadequate and become, as one would expect, a cause of leakage and hose blow-off. Bulging is thus one aspect of the essential performance of a hose. According to the findings by the inventors, increasing the modulus of elasticity of the rubber at high temperature is effective for suppressing bulging. One conceivable way to increase the modulus of elasticity is to increase the amounts of reinforcement and crosslinking agent (sulfur), although this brings about a decrease in the ease of processing operations due to increased viscosity and a decrease in the heat resistance. By adding a suitable amount of bismaleimide as a co-crosslinking agent to address this problem, the high-temperature modulus of elasticity can be increased without lowering the heat resistance or ease of processing operations, and the occurrence of bulging can be effectively suppressed.

The amount of bismaleimide added is preferably from 1 to 5 parts by mass, and more preferably from 2 to 4 parts by mass, per 100 parts by mass of the rubber component. At a bismaleimide content of less than 1 part by mass, a sufficient high-temperature modulus of elasticity-increasing effect cannot be obtained. On the other hand, the addition of more than 5 parts by mass only increases the cost without providing further improvement in the effects. The type of bismaleimide is not particularly limited; any bismaleimide that is known as a co-crosslinking agent may be suitably selected and used. Preferred use can be made of, for example, N,N′-m-phenylenedimaleimide (available as “Vulnoc PM” from Ouchi Shino Chemical Industry Co., Ltd.), N,N′-(4,4′-diphenylmethane)bismaleimide (available as “BMI-RB” from Daiwa Kasei Industry Co., Ltd.), N,N′-1,2-phenylenebismaleimide, N,N′-1,3-phenylenebismaleimide, N,N′-1,4-phenylenebismaleimide, N,N′-(4,4′-diphenylmethane)bismaleimide, 2,2-bis[4-(4-maleimidophenoxy)phenyl]propane and bis(3-ethyl-5-methyl-4-maleimidophenyl)methane.

The use of N,N′-m-phenylenedimaleimide and N,N′-(4,4′-diphenylmethane)bismaleimide is more preferred.

Sulfur may be used as a crosslinking agent in the rubber composition of the invention. The content thereof may be set to preferably from 1.5 to 3 parts by mass, more preferably from 1.5 to 2.5 parts by mass, and even more preferably from 1.5 to 2 parts by mass, per 100 parts by mass of the rubber component. At a content in excess of 3 parts by mass, good adhesion is obtained, but the heat resistance may end up decreasing. On the other hand, at less than 1.5 parts by mass, the adhesion may decrease.

Zinc oxide (zinc white) may be included as a vulcanization accelerator. The content thereof may be set to preferably from 0.5 to 10 parts by mass, and especially from 0.5 to 3 parts by mass, per 100 parts by mass of the rubber component. A content in excess of 10 parts by mass may lead to a decline in adhesion. On the other hand, at a content of less than 0.5 part by mass, a vulcanization rate-increasing effect may be substantially unattainable.

Here, although not particularly limited, the relative proportions in which the sulfur and the zinc white are included (expressed as sulfur/zinc white (ratio by mass)) is set to preferably 0.4 or more, and more preferably 2.0 or more. The upper limit is set to preferably 6.0 or less, and more preferably 3.0 or less. In cases where the ratio falls outside of the above range, this may lead to a decline in adhesion.

In this invention, if necessary, crosslinking agents (vulcanizers), vulcanization accelerators and vulcanization co-accelerators, and commonly used additives such as carbon, antidegradants, plasticizers, petroleum resins, vulcanization retarders, waxes, antioxidants, fillers, blowing agents, oils, lubricants, tackifiers, ultraviolet absorbers, dispersants, solubilizing agents and homogenizing agents may be suitably included in the above rubber component within a range that does not detract from the advantageous effects of the invention.

The carbon used may be a known carbon. Illustrative examples include, but are not particularly limited to, carbon blacks such as SRF, GPF, FEF, HAF, ISAF, SAF, FT and MT. In this invention, preferred use can be made of SRF. These carbon blacks may be used singly, or two or more may be used together. The content of carbon black per 100 parts by mass of the rubber component is preferably from 50 to 150 parts by mass, and especially from 80 to 120 parts by mass. At a content in excess of 150 parts by mass, the viscosity of the unvulcanized rubber may rise excessively, which may lower the ease of kneading, rolling and extrusion operations. On the other hand, at less than 50 parts by mass, the strength required as a hydraulic hose may be unattainable.

The antidegradant used may be a known antidegradant. Although not particularly limited, one, two or more phenolic antidegradants, imidazole-type antidegradants, amine-type antidegradants or the like may be used. The content of antidegradant is preferably set to from 1 to 3 parts by mass per 100 parts by mass of the rubber component.

The plasticizer used may be a known plasticizer. Examples include, but are not particularly limited to, process oils such as aromatic oils, naphthenic oils and paraffinic oils; vegetable oils such as coconut oil and castor oil; synthetic oils such as alkylbenzene oils; and ester-type plasticizers such as dioctyl adipate (DOA). These may be used singly or two or more may be used in combination. The content of these plasticizers is preferably set to from 5 to 15 parts by mass per 100 parts by mass of the rubber component.

The petroleum resin used may be a known aromatic hydrocarbon resin, aliphatic hydrocarbon resin or the like. These petroleum resins may be used singly or two or more may be used in combination. The content of these petroleum resins is preferably set to from 1 to 5 parts by mass per 100 parts by mass of the rubber component.

The vulcanization retarder used may be one that is known. Although not particularly limited, an illustrative example is N-cyclohexylthiophthalamide (available as “Santogard PVI” from Monsanto Company). The content of vulcanization retarder is preferably set to from 0.1 to 1 part by mass per 100 parts by mass of the rubber component.

When obtaining the rubber composition of the invention, the method of blending the various above ingredients is not particularly limited. The ingredient starting materials may all be blended together and kneaded at one time, or kneading may be carried out after dividing up and blending the ingredients in two or three stages. During kneading, use may be made of a mixing apparatus such as a roll mill, internal mixer or Banbury rotor.

The vulcanization conditions when curing the rubber composition are not particularly limited, although vulcanization conditions of from 140 to 180° C. and from 10 to 90 minutes may generally be used.

A conventional method may be used to manufacture a rubber hose having a reinforcing layer using the rubber composition of the invention. For example, when manufacturing, as shown in FIG. 1, a hydraulic hose 1 having built up therein as successive layers an inner rubber layer 2 (inner tube rubber) that is made of rubber and is filled with hydraulic fluid, a reinforcing layer 3 for withstanding the pressure of the hydraulic fluid, and an outer rubber layer 4 (outer cover rubber) that prevents the reinforcing layer 3 and the inner rubber layer 2 from incurring damage, production may be carried out by the following method.

First, the rubber composition of the invention is extruded over a core (mandrel) having about the same diameter as the hose inner diameter, thereby covering the mandrel and forming the inner rubber layer (inner tube rubber) 2 (inner tube extrusion step). A given number of brass-plated wires are then braided over the inner rubber layer 2 formed in the inner tube extrusion step so as to build up a reinforcing layer 3 (braiding step), following which the rubber composition used to form the outer cover of the hose is extruded over the reinforcing layer 3, thereby forming an outer rubber layer (outer cover rubber) 4 (outer cover extrusion step). In addition, the outer rubber layer 4 formed in the outer cover extrusion step is covered on the outside with resin (resin mold covering step), and then vulcanization is carried out under the usual conditions (vulcanization step). Following vulcanization, the covering resin is peeled off (resin mold peeling step) and the mandrel is removed (mandrel extraction step), thereby giving a hydraulic hose 1 having a reinforcement layer 3 between the inner tube rubber 2 and the outer covering rubber 4. In the hydraulic hose 1 thus obtained, the inner tube rubber 2 and the brass-plated wire of the reinforcing layer 3 are firmly bonded together and have an excellent durability that keeps them from separating even under harsh conditions of use.

Moreover, because there is no need to use tackifiers that increase the cost of the rubber, a hose having an excellent cost performance can be obtained. In addition, there is no risk of adverse effects on rubber properties other than adhesion, such as increased hardness, decreased workability and retarding of the vulcanization rate of the rubber, due to the addition of various types of tackifiers.

The hydraulic hose 1 may be given a three-layer construction like that described above having, as successive layers from the inside: an inner tube rubber 2, a reinforcing layer 3 and an outer cover rubber 4. In cases where greater strength, etc. is required, although not shown in the diagram, the hose may be given a five-layer construction in which the number of reinforcing layers has been increased to two and an intermediate layer (intermediate rubber) is disposed between the two reinforcing layers. These constructions may be suitably selected according to such considerations as the required properties of the hose.

### EXAMPLES

The invention is illustrated more fully below by way of Working Examples and Comparative Examples, although the invention is not limited by these Examples.

### Example 1 and Comparative Example 1

A rubber composition for hoses was prepared by kneading in the usual manner the formulation shown for Example 1 in Table 1 below. This was treated as the basic formulation. The kneading operation at this time entailed, first, adding each the compounding ingredients, except for the vulcanizing agent, to the starting rubber and kneading with a Banbury mixer or a kneader (non-processing kneading), removing the kneaded material from the mixing apparatus and thoroughly cooling it, then adding the remaining compounding ingredients, including the vulcanizing agent, and returning the material again to the kneading apparatus and kneading (processing kneading). The adhesion, high-temperature modulus of elasticity G′, scorching time and appearance (bloom) of the resulting rubber composition were evaluated by the methods described below. The results are presented in Table 1. In addition, a conventionally formulated rubber composition that uses a conventional vulcanization accelerator was similarly prepared as Comparative Example 1, and the adhesion, modulus of elasticity G′ at high temperature, scorching time and appearance (bloom) were similarly evaluated. These results also are presented in Table 1. The ingredient amounts in the tables below are all in parts by mass.

### [Adhesion (Wire Peeling Test)]

Seven brass-plated wires were arranged together in a mutually contacting state on and attached to the surface of a sheet of the unvulcanized rubber composition, and vulcanized at 150° C. for 60 minutes, following which the five wires other than the two edge wires were peeled off one at a time. The surface area over which rubber adhered to a peeled wire was expressed as a percentage, with 100% representing a state where rubber adhered to the entire surface where the wire and rubber were in contact. The average for the five wires was used as the measurement result.

### [Modulus of Elasticity G′ at High Temperature]

Using an Alpha Technologies RPA 2000 Rubber Process Analyzer, the rubber composition was vulcanized under conditions of 150° C. and 60 minutes, and the modulus of elasticity G′ (at 150° C., 1 Hz, 1%) was measured.

### [Scorching Time]

The scorching time (t5) was measured in accordance with JIS K-6300 using a rotorless Mooney tester from Toyo Seiki Kogyo Co., Ltd.

### [Appearance (Bloom)]

The rubber composition was heated and vulcanized under conditions of 150° C. and 60 minutes, fabricating 140 mm×140 mm×2 mm test pieces. These were left to stand at room temperature for 168 hours, following which the appearance was examined and rated as follows. Good: no bloom; Fair: a little bloom; NG: much bloom.

TABLE 1

| | Example 1 | Comparative Example 1 |
|---|---|---|
| | (basic formulation) | (conventional formulation) |
| NBR | 100.00 | 100.00 |
| Carbon black | 100.00 | 100.00 |
| Antidegradant | 1.00 | 1.00 |
| Petroleum resin | 2.00 | 2.00 |
| Plasticizer | 10.00 | 10.00 |
| Phenolic resin | 3.00 | |
| Sulfur | 2.00 | 2.00 |
| Bismaleimide | 3.00 | |
| Accelerator TS | | 1.25 |
| Accelerator DM | | 0.50 |
| Accelerator TBZTD | 3.00 | |
| Zinc white | 1.00 | 1.00 |
| Vulcanization retarder | 0.50 | 0.50 |
| Adhesion (%) | 100 | 100 |
| G′ at 150° C. (MPa) | 2.96 | 2.62 |
| t5 (min) | 13.1 | 16.4 |
| Appearance (bloom) | Good | Good |

Details on the ingredients in Table 1 are given below. The same applies also to Tables 2 and 3 below.
NBR: “JSR N230S” from JSR Corporation (AN content, 35% by mass)
Carbon Black: An SRF-grade carbon black, available as “Asahi #50” from Asahi Carbon Co., Ltd.
Antidegradant: “Nocrac 224” from Ouchi Shinko Chemical Industry Co., Ltd.
Petroleum Resin: A C4-C5 hydrocarbon fraction polymer, available as “ESCOREZ 1102,” from Tonen Chemical Corporation
Plasticizer: Dioctyl adipate (DOA), available as “Sanso Cizer DOA” from New Japan Chemical Co., Ltd.
Sulfur: “Sulfax 5” from Tsurumi Chemical
Vulcanization Accelerator TS:
   TMTM, available as “Nocceler TS” from Ouchi Shinko Chemical Industry Co., Ltd.
Vulcanization Accelerator DM:
   MBTS, available as “Nocceler DM” from Ouchi Shinko Chemical Industry Co., Ltd.
Vulcanization Accelerator TBZTD:
   TBZTD, available as “Nocceler TBZTD” from Ouchi Shinko Chemical Industry Co., Ltd.
Zinc White: “Ginrei SR” from Toho Zinc Co., Ltd.
Vulcanization Retarder:
   “Santogard PVI” from Monsanto Company
Phenolic Resin: “Sumilite Resin PR-12687” from Sumitomo Bakelite Co., Ltd.
Bismaleimide: “Vulnoc PM” from Ouchi Shinko Chemical Industry Co., Ltd.

As shown in Table 1, the rubber composition of Example 1 according to this invention uses TBZTD, which does not generate nitrosamines and thus poses little environmental risk. Moreover, it possesses an excellent adhesion to brass-plated wire, has a good scorching time, and does not exhibit a bloom, giving the vulcanizate an excellent appearance. In addition, the modulus of elasticity at high temperature (150° C.) is sufficient, enabling the occurrence of bulging to be prevented. By contrast, the rubber composition of Comparative Example 1, which is a conventional formulation, poses a high environmental risk because it uses as the vulcanization accelerator tetramethylthiuram monosulfide (TMTM), which may generate nitrosamines. In addition, the high-temperature modulus of elasticity is somewhat low, and so the possibility that bulging will occur is higher than for Example 1.

### Examples 2 and 3, Comparative Examples 2 to 7

The adhesion, high-temperature modulus of elasticity, scorching time and appearance (bloom) for various compounding formulations obtained by, relative to the basic formulation (Example 1) in Table 1 above, varying the contents of the various ingredients were investigated.

First, cases in which the content of the vulcanization accelerator TBZTD was varied were investigated. The results are shown in Table 2. The results for Example 1 above (basic formulation) are also presented in Table 2.

TABLE 2

| | Example | | | Comparative Example | | | | | |
|---|---|---|---|---|---|---|---|---|---|
| | 2 | 1 (Basic) | 3 | 2 | 3 | 4 | 5 | 6 | 7 |
| NBR | 100.00 | 100.00 | 100.00 | 100.00 | 100.00 | 100.00 | 100.00 | 100.00 | 100.00 |
| Carbon black | 100.00 | 100.00 | 100.00 | 100.00 | 100.00 | 100.00 | 100.00 | 100.00 | 100.00 |
| Antidegradant | 1.00 | 1.00 | 1.00 | 1.00 | 1.00 | 1.00 | 1.00 | 1.00 | 1.00 |
| Petroleum | 2.00 | 2.00 | 2.00 | 2.00 | 2.00 | 2.00 | 2.00 | 2.00 | 2.00 |
| resin | | | | | | | | | |
| Plasticizer | 10.00 | 10.00 | 10.00 | 10.00 | 10.00 | 10.00 | 10.00 | 10.00 | 10.00 |
| Phenolic | 3.00 | 3.00 | 3.00 | 3.00 | 3.00 | 3.00 | 3.00 | 3.00 | 3.00 |
| resin | | | | | | | | | |
| Sulfur | 2.00 | 2.00 | 2.00 | 2.00 | 2.00 | 2.00 | 2.00 | 2.00 | 2.00 |
| Bismaleimide | 3.00 | 3.00 | 3.00 | 3.00 | 3.00 | 3.00 | 3.00 | 3.00 | 3.00 |
| Accelerator | 1.00 | 3.00 | 5.00 | 6.00 | 0.50 | 0.60 | 0.70 | 0.80 | 0.90 |
| TBZTD | | | | | | | | | |
| Zinc white | 1.00 | 1.00 | 1.00 | 1.00 | 1.00 | 1.00 | 1.00 | 1.00 | 1.00 |
| Vulcanization | 0.50 | 0.50 | 0.50 | 0.50 | 0.50 | 0.50 | 0.50 | 0.50 | 0.50 |
| retarder | | | | | | | | | |
| Adhesion (%) | 80 | 100 | 100 | 100 | 30 | 30 | 30 | 30 | 50 |
| G′ at 150° C. | 2.71 | 2.96 | 3.22 | 3.30 | 2.65 | 2.65 | 2.66 | 2.68 | 2.70 |
| (MPa) | | | | | | | | | |
| t5 (min) | 17.1 | 13.1 | 11.7 | 9.4 | 19.7 | 19.5 | 19.4 | 18.9 | 17.7 |
| Appearance | Good | Good | Fair | NG | Good | Good | Good | Good | Good |
| (bloom) | | | | | | | | | |

(Basic): Basic formulation

As shown in Comparative Example 2 in Table 2 above, when the content of the vulcanization accelerator TBZTD exceeds 5 parts by mass, the scorching time becomes very short and the scorching stability greatly declines. In addition, bloom increases, so that a good appearance cannot be obtained. On the other hand, as shown in Comparative Examples 3 to 7, when the content of the vulcanization accelerator TBZTD is less than 1 part by mass, sufficient adhesion is not obtained, making it impossible to achieve the objects of the invention. In addition, the high-temperature modulus of elasticity is low compared with Examples 1 to 3, meaning that there is an increased possibility of bulge occurring.

### Examples 4 to 11, Comparative Examples 8 to 11

Next, cases in which the contents of the phenolic resin and the bismaleimide were varied relative to the basic formulation (Example 1) in Table 1 above were investigated. A case in which tetrakis(2-ethylhexyl)thiuram disulfide (TOT) was used as the vulcanization accelerator (Example 11) instead of TBZTD was also investigated. The results are shown in Table 3. The results for Example 1 above (basic formulation) are also presented in Table 3.

TABLE 3

| | Example | | | | | | | | | Comparative Example | | | |
|---|---|---|---|---|---|---|---|---|---|---|---|---|---|
| | 1 (Basic) | 4 | 5 | 6 | 7 | 8 | 9 | 10 | 11 | 8 | 9 | 10 | 11 |
| NBR | 100.00 | 100.00 | 100.00 | 100.00 | 100.00 | 100.00 | 100.00 | 100.00 | 100.00 | 100.00 | 100.00 | 100.00 | 100.00 |
| Carbon black | 100.00 | 100.00 | 100.00 | 100.00 | 100.00 | 100.00 | 100.00 | 100.00 | 100.00 | 100.00 | 100.00 | 100.00 | 100.00 |
| Antidegradant | 1.00 | 1.00 | 1.00 | 1.00 | 1.00 | 1.00 | 1.00 | 1.00 | 1.00 | 1.00 | 1.00 | 1.00 | 1.00 |
| Petroleum resin | 2.00 | 2.00 | 2.00 | 2.00 | 2.00 | 2.00 | 2.00 | 2.00 | 2.00 | 2.00 | 2.00 | 2.00 | 2.00 |
| Plasticizer | 10.00 | 10.00 | 10.00 | 10.00 | 10.00 | 10.00 | 10.00 | 10.00 | 10.00 | 10.00 | 10.00 | 10.00 | 10.00 |
| Phenolic resin | 3.00 | 2.00 | 1.00 | 4.00 | 3.00 | 3.00 | 3.00 | 3.00 | 3.00 | | | 5.00 | 6.00 |
| Sulfur | 2.00 | 2.00 | 2.00 | 2.00 | 2.00 | 2.00 | 2.00 | 2.00 | 2.00 | 2.00 | 2.00 | 2.00 | 2.00 |
| Bismaleimide | 3.00 | 3.00 | 3.00 | 3.00 | 5.00 | 2.00 | 1.00 | | 3.00 | 3.00 | | 3.00 | 3.00 |
| Accelerator TBZTD | 3.00 | 3.00 | 3.00 | 3.00 | 3.00 | 3.00 | 3.00 | 3.00 | | 3.00 | 3.00 | 3.00 | 3.00 |
| Accelerator TOT | | | | | | | | | 3.00 | | | | |
| Zinc white | 1.00 | 1.00 | 1.00 | 1.00 | 1.00 | 1.00 | 1.00 | 1.00 | 1.00 | 1.00 | 1.00 | 1.00 | 1.00 |
| Vulcanization retarder | 0.50 | 0.50 | 0.50 | 0.50 | 0.50 | 0.50 | 0.50 | 0.50 | 0.50 | 0.50 | 0.50 | 0.50 | 0.50 |
| Adhesion (%) | 100 | 85 | 80 | 100 | 100 | 100 | 100 | 100 | 80 | 0 | 0 | 100 | 100 |
| G′ at 150° C. (MPa) | 2.96 | 3.01 | 3.13 | 2.70 | 3.14 | 2.87 | 2.75 | 2.53 | 2.82 | 3.17 | 3.01 | 2.68 | 2.60 |
| t5 (min) | 13.1 | 13.8 | 14.2 | 9.7 | 11.8 | 13.3 | 13.4 | 12.8 | 19.3 | 15.5 | 15.1 | 9.10 | 8.70 |
| Appearance (bloom) | Good | Good | Good | Good | Good | Good | Good | Good | Good | Good | Good | Good | Good |

(Basic): Basic formulation

### Vulcanization Accelerator TOT:

Tetrakis(2-ethylhexyl)thiuram disulfide, available as “Nocceler TOT-N”
from Ouchi Shinko Chemical Industry Co., Ltd.

As shown in Comparative Examples 8 and 9 in Table 3 above, when a phenolic resin is not included, sufficient adhesion cannot be obtained and the objects of the invention are not achievable. On the other hand, as shown in Comparative Examples 10 and 11, if there is too much phenolic resin, the high-temperature modulus of elasticity decreases and the scorching time shortens. However, it was confirmed from Example 1 and Examples 4 to 6 that by also using a suitable amount of phenolic resin, excellent adhesion is obtained even in cases where TBZTD is used as the vulcanization accelerator. Also, on comparing Example 10, which does not contain bismaleimide, with other examples of the invention, namely, Example 1 and Examples 4 to 9, it is clearly demonstrated that adding bismaleimide increases the high-temperature modulus of elasticity. Moreover, as demonstrated in Example 11, even when tetrakis(2-ethylhexyl)thiuram disulfide (TOT) is used as the vulcanization accelerator, it was confirmed that, as in cases where TBZTD was used, an excellent adhesion with the brass-coated wire is exhibited, the scorching time is good, and the vulcanizate has an excellent appearance with no apparent bloom. Furthermore, this TOT poses little environmental risk because it does not generate nitrosamines.

1. A rubber composition for hoses, characterized by comprising 100 parts by mass of a rubber component, of which at least 80 parts by mass is an acrylonitrile-butadiene rubber (NBR); from 1 to 4 parts by mass of a phenolic resin; and, as a vulcanization accelerator, from 1 to 5 parts by mass of a thiuram compound of general formula (1) below 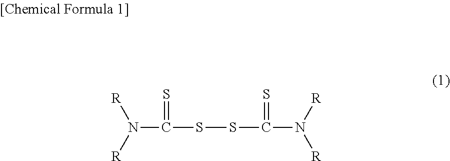
(wherein R is at each occurrence an alkyl group or aryl group of 6 or more carbons, each of which occurrences may be different or two or more of which may be the same).

2. The rubber composition for hoses according to claim 1 which includes, as the thiuram compound of general formula (1), one or both of tetrabenzylthiuram disulfide and tetrakis(2-ethylhexyl)thiuram disulfide.

3. The rubber composition for hoses according to claim 1 which includes from 1 to 5 parts by mass of bismaleimide.

4. The rubber composition for hoses according to claim 1 which includes from 1.5 to 3 parts by mass of sulfur.

5. The rubber composition for hoses according to claim 1 which includes from 0.5 to 10 parts by mass of zinc oxide (zinc white).

6. The rubber composition for hoses according to claim 1 which is a rubber composition that forms, in a rubber hose having a reinforcing layer made of brass-plated wire, a rubber layer which bonds directly with the brass-plated wire of the reinforcing layer.

7. A hose comprising at least an inner tube rubber and a reinforcing layer made of brass-plated wire that is formed over the inner tube rubber, wherein the inner tube rubber is formed of the rubber composition according to claim 1.

8. The hose according to claim 7 which is a hydraulic hose that is filled with a hydraulic fluid for hydraulically powered equipment.
